(19) United States
(12) Patent Application Publication
(10) Pub. No.: US 2006/0016111 A1
(43) Pub. Date: Jan. 26, 2006

(54) Real estate to go sign post

(76) Inventor: Lanny Clifton Simmons, Tampa, FL (US)

Correspondence Address: Lanny C. Simmons, 6722 S. Dauphin Avenue, Tampa, FL, 33611-5410, US

(21) Appl. No.: 10/897,660

(22) Filed: Jul. 23, 2004

(51) Int. Cl. G09F 15/00

(52) U.S. Cl. 40/607.04; 40/607.09

(57) ABSTRACT

The Real Estate To Go Sign Post is a telescoping structure with three retractable and extendable supports. This signpost can be retracted to make it smaller than wooden posts for easy transportation. It can then be quickly installed and extended for immediate use. This signpost also has extra features. These are: a theft prevention locking system for the post and installed real estate signs, a document storage compartment for information sheets about the property being offered, and for business cards for the business of person selling or leasing the property. The sign post comes with a choice of three different mounting bases: the conventional base which can be installed in a hole in the ground, the sand or water-filled base which can be placed on a surface and filled with a sufficient amount of sand or water to support the structure, and a quick-install base with spikes that can be hammered into the ground.

### BACKGROUND OF THE INVENTION

The Real Estate To Go Signpost is designed to provide an all weather and lightweight signpost for the installation of real estate signs. Current signposts are typically constructed of wood. This invention is much lighter than conventional wooden posts. Wooden posts are long, heavy, and difficult to transport. The Real Estate To Go signpost is a retractable and extendable telescoping assembly. The Real Estate To Go Signpost can be retracted for easy transportation. Its telescoping design provides for easy extension and installation on one of the three optional bases available. The Real Estate To Go signpost provides a locking system to for theft prevention of installed real estate signs and the signpost itself. Unlike conventional wooden posts, the Real Estate To Go Signpost provides a storage compartment for business cards and marketing flyers.

### BRIEF SUMMARY OF THE INVENTION

The Real Estate To Go Signpost is an all weather, lightweight, plastic telescoping structure consisting of three external vertical square beams and two horizontal beams mounted perpendicular. Three internal vertical support rods support the entire assembly. The Real Estate To Go Signpost is a retractable and extendable assembly. Current signposts are typically made from 4 inch by 4 inch diameter wood. These wooden posts are extremely heavy and very bulky. The Real Estate To Go Signpost can be retracted for easy transportation. The signpost provides a locking system for security of installed real estate signs and the signpost itself. Once delivered to the site, the Real Estate To Go Signpost can be quickly set up by placing it on one of the three optional bases, extending it, and installing the signs, end caps and lock pin.

### BRIEF DESCRIPTION OF DRAWINGS

FIG. 1 is a front perspective view of the three vertical support posts and three beams.

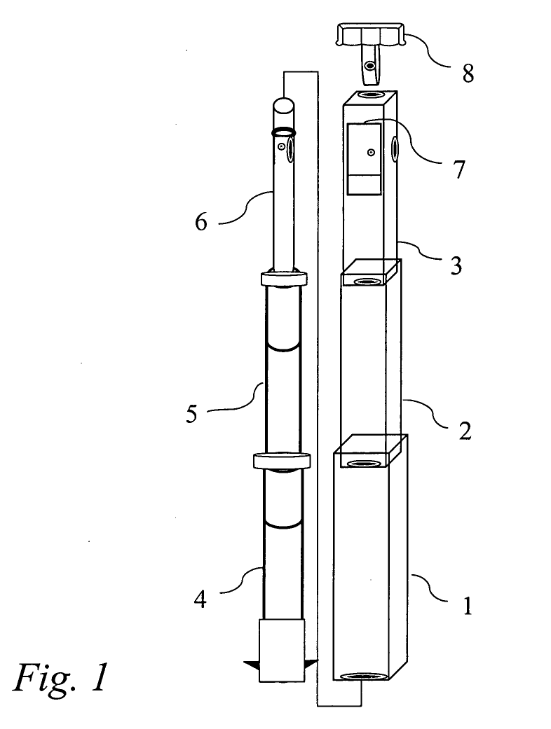

FIG. 2 is a front perspective view of the horizontal beam assembly.

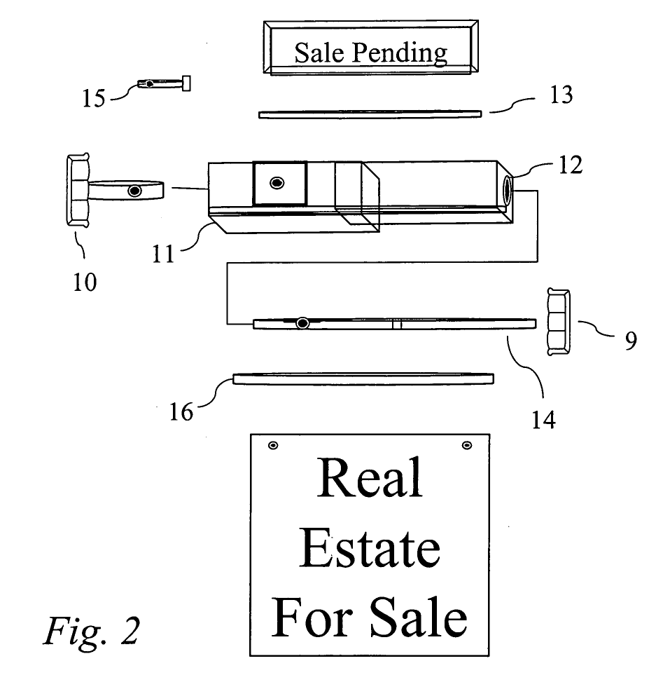

FIG. 3 is a front perspective view of the completely assembled Real Estate To Go Signpost and optional bases.

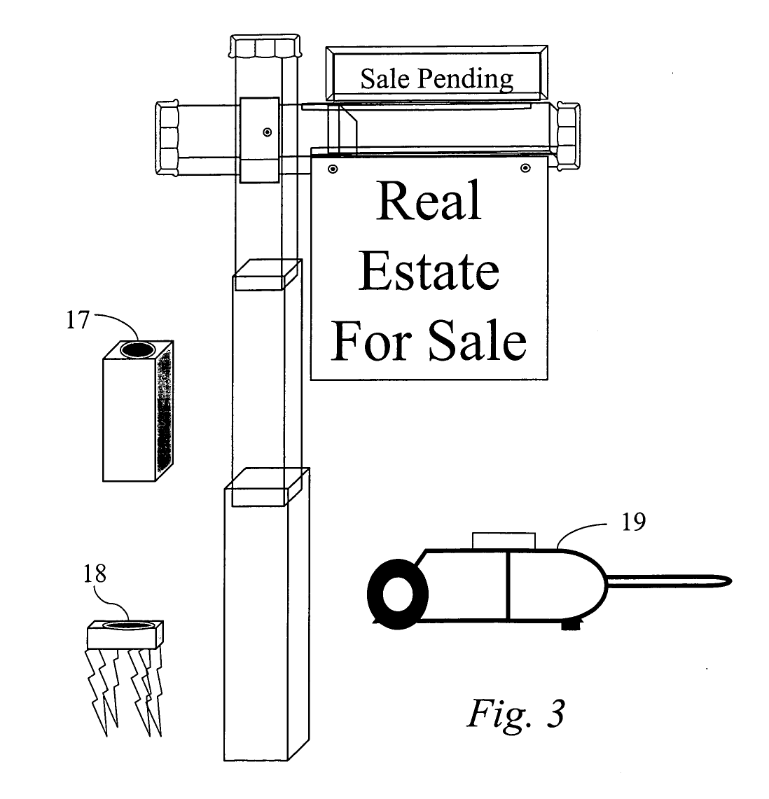

### DETAILED DESCRIPTION OF THE INVENTION

The Real Estate To Go Signpost is an all weather, lightweight, plastic telescoping structure consisting of three external vertical square beams. This invention is designed to provide a lighter and smaller signpost for the installation of real estate signs. The Real Estate To Go Signpost is a retractable and extendable assembly. Its telescoping design provides for easy extension and installation. It is lighter and smaller than conventional wooden posts.

The Real Estate To Go Signpost incorporates a locking system for theft protection of installed real estate signs and the signpost itself. Current posts are typically made from 4 inch by 4 inch diameter wood. These wooden posts are extremely heavy and very bulky. The Real Estate To Go Signpost can be retracted for easy transportation. Once delivered to the site, the post can be quickly set up by placing it on one of the three optional bases, extending it and installing the real estate signs, end caps, and lock pin.

The signpost's design includes: A lower vertical beam (1) measuring 24 inches long (extended) and 4.5 inches by 4.5 inches in diameter, a center vertical beam (2) measuring 24 inches long (extended) and 4.25 inches by 4.25 inches in diameter, and an upper vertical beam (3) measuring 24 inches long (extended) and 4.0 inches by 4.0 inches in diameter. The upper vertical beam incorporates a storage compartment for flyers and features a clear plastic door with a built in shelf for storage of business cards (7).

Three round corresponding internally mounted telescoping poles are used to support the entire assembly. These are: the lower support post (4), center support post (5), and the upper support post (6).

An inner horizontal telescoping beam, (11) measuring 23 inches long and 4.25 inches by 4.25 inches in diameter, and an outer horizontal beam (12) measuring 23 inches long and 4.0 inches by 4.0 inches in diameter, are mounted perpendicular to the vertical beam. The horizontal beams provide for the mounting of real estate signs above and below the beams. Real estate signs mounted above the horizontal beams are installed using the upper slider rail (13). Real estate signs mounted below the horizontal beams are installed using the lower slider rail (16). The horizontal beam incorporates a swivel action during periods of high winds. Three end caps (8), (9), (10) cover the ends of the beams.

The structure incorporates a locking system that secures the entire post assembly and installed real estate signs. The locking system includes: the lateral support rod (14), and the locking pin (15). The locking pin is installed in the right side of the horizontal beam (11) and passes perpendicular through a hole in the lateral support/lock rod (14) causing the two to interlock. A conventional padlock is then installed in a hole in the end of the locking pin (15) inside of the storage compartment (7) securing the entire assembly.

The Real Estate To Go Signpost features three different optional bases for installation of the post: the conventional base (17) to be installed in a hole and buried, the spiked base (18), to be hammered into the ground for quick installation, and the water or sand filled base (19). This base has wheels located at the rear and a retractable handle for repositioning and ease of transport.

What is claimed is:

1. An all-weather, lightweight, plastic telescoping structure consisting of three external vertical square beams.

2. A lower vertical beam measuring 24 inches long (extended) and 4.5 by 4.5 inches in diameter, a center vertical beam measuring 24 inches long (extended) and 4.25 by 4.25 inches in diameter, and an upper vertical beam measuring 24 inches long (extended) and 4.0 by 4.0 inches in diameter.

3. Three round internally mounted telescopic poles used to support the entire assembly.

4. A locking system for the post assembly and installed real estate signs utilizing a conventional padlock.

5. An inner horizontal telescoping beam, measuring 23 inches long and 4.25 inches by 4.25 inches in diameter, and an outer horizontal beam (12) measuring 23 inches long and 4.0 inches by 4.0 inches in diameter.

6. A storage compartment in the upper vertical beam for flyers featuring a clear plastic door for visible storage of business cards.

7. Three different optional bases for installation of the post: the conventional base to be installed in a hole and buried, the spiked base, to be hammered into the ground for quick installation, and the water or sand filled base. This base has wheels located at the rear and a retractable handle for ease of transport.

8. A horizontal beam with ability to swivel during high winds.
